(19) United States
(12) Patent Application Publication
(10) Pub. No.: US 2006/0055796 A1
(43) Pub. Date: Mar. 16, 2006

(54) Image processing apparatus

(75) Inventor: Makoto Matsui, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 10/942,488

(22) Filed: Sep. 16, 2004

(51) Int. Cl. H04N 5/76

(52) U.S. Cl. 348/231.2

(57) ABSTRACT

An image processing apparatus including a first memory which stores data indicating working contents concerning image processing, a connection unit communicatably connected to an external apparatus having a second memory which backs up the data indicating the working contents to be stored in the first memory, a backup unit configured to back up the data indicating the working contents to be stored in the first memory by the second memory, and a processing unit configured to perform working concerning the image processing using the second memory in a case where it is not possible to perform the working using the first memory.

### BACKGROUND OF THE INVENTION

1. Field of the Invention

The present invention relates to an image processing apparatus using a large-capacity storage unit in processing an image.

2. Description of the Related Art

In Jpn. Pat. Appln. KOIAI Publication No. 2003-234863, a data communication apparatus has been described comprising a document information memory accessible only by a facsimile control unit; a facsimile control function unit which backs up reception information stored in the document information memory; and a hard disk accessible by another control unit and connected to an external apparatus such as a computer apparatus via an interface. The data communication apparatus is capable of copying document information backed up by the hard disk to the document information memory and restoring the document information when the document information of the document information memory is accidentally erased.

In this data communication apparatus or the like, if a hard disk drive in the apparatus has broken down, and does not work, and even though other parts are operable normally, a working area cannot be used until the hard disk drive is repaired.

Therefore, there has been a need for an image processing apparatus capable of operating even in a case where trouble occurs in a large-capacity storage unit such as a hard disk drive or the like required for processing images and the storage unit becomes inoperative.

### BRIEF SUMMARY OF THE INVENTION

According to an aspect of the present invention, there is provided an image processing apparatus comprising: a first memory which stores data indicating working contents concerning image processing; a connection unit communicatably connected to an external apparatus having a second memory which backs up the data indicating the working contents to be stored in the first memory; a backup unit configured to back up the data indicating the working contents to be stored in the first memory by the second memory; and a processing unit configured to perform working concerning the image processing using the second memory in a case where it is not possible to perform the working using the first memory.

Objects and advantages of the invention will become apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 is a diagram showing a network structure in one embodiment of the present invention;

FIG. 2 is a diagram schematically showing an inner structure of an image processing apparatus;

FIG. 3A is a diagram showing a correspondence between storage areas of HDDs for two image processing apparatuses;

FIG. 3B is an explanatory view of an operation in a case where an HDD has broken down;

FIG. 3C is an explanatory view or recovery at a time when the HDD has been changed;

FIG. 4 is a diagram schematically showing an inner structure of a PC;

FIG. 5A is a diagram showing a correspondence between the storage areas of the HDDs of the image processing apparatus and the PC;

FIG. 5B is an explanatory view of an operation in a case where an HDD has broken down;

FIG. 5C is an explanatory view or the recovery at a time when the HDD has been changed;

FIG. 6 is a diagram showing a correspondence among the storage areas of the RDDs in a case where three image processing apparatuses back up one another;

FIG. 7 is a diagram showing a correspondence among the storage areas of the HDDs in a case where four image processing apparatuses back up one another;

FIG. 8 is a diagram showing a correspondence among the storage areas of the HDDs in a case where five image processing apparatuses back up one another;

FIG. 9 is a diagram showing a correspondence among the storage areas of the HDDs in a case where the PC backs up two image processing apparatuses;

FIG. 10 is a diagram showing a correspondence among the storage areas of the HDDs in a case where the PC backs up three image processing apparatuses;

FIG. 11 is a diagram showing a correspondence among the storage areas of the HDDs in a case where the PC backs up four image processing apparatuses;

FIG. 12 is a diagram showing another correspondence among the storage areas of the HDDs in a case where the PC backs up four image processing apparatuses;

FIG. 13 is a diagram showing a correspondence among the storage areas in a case where backup is performed utilizing media;

FIG. 14 is a diagram showing details of data stored in NVRAM;

FIG. 15 is a diagram showing details of data stored in RAM;

FIG. 16 is a diagram showing contents of data stored in the HDD of the MFP;

FIG. 17 is a diagram showing contents of data stored in the HDD of the PC;

FIG. 18 is a table showing details of a backup file work area in a case where the backup is performed with respect to the image processing apparatus or the PC;

FIG. 19 is a table showing details of the backup file work area in a case where the backup is performed with respect to the media;

FIG. 20 is a diagram showing a control panel;

FIG. 21 is a diagram showing contents displayed on a part of a display section of the control panel;

FIG. 22 is a flowchart showing an operation procedure of the image processing apparatus;

FIG. 23A is a flowchart showing a first half of a usual process of the image processing apparatus;

FIG. 23B is a flowchart showing a last half of the usual process of the image processing apparatus;

FIG. 24 is a flowchart showing various setting processes for setting the NVRAM;

FIG. 25 is a flowchart showing a print task;

FIG. 26 is a flowchart showing a network print task;

FIG. 27A is a flowchart showing a first half of a backup task;

FIG. 27B is a flowchart showing a last half of the backup task;

FIG. 28 is a flowchart showing a copy backup process;

FIG. 29 is a flowchart showing a scan backup process;

FIG. 30 is a flowchart showing a print backup process;

FIG. 31 is a flowchart showing a setINF process;

FIG. 32 is a flowchart showing an operation procedure of the PC in a case where the backup is performed utilizing the PC;

FIG. 33A is a flowchart showing a first half of the backup task;

FIG. 335 is a flowchart showing a last half of the backup task; and

FIG. 34 is a flowchart showing an HDD_INIT_Recovery (ID) process.

### DETAILED DESCRIPTION OF THE INVENTION

One embodiment of the present invention will be described hereinafter with reference to the drawing.

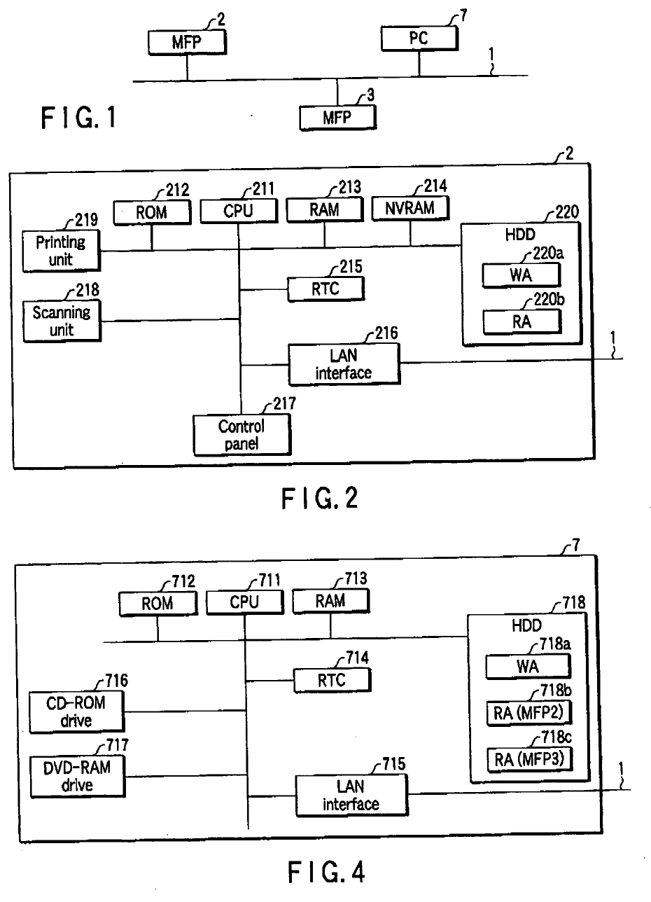

FIG. 1 is a diagram showing a network structure, A local area network (LAN) 1 is connected to a multi-functional peripheral (MFP) 2, an MFP 3, and a personal computer (PC) 7. The MFPs 2, 3 are image processing apparatuses each having a plurality of functions including a copying function, network scanning function, a network printing function and the like.

Schematic inner structures of the MFPs 2, 3 will be described with reference to FIG. 2. It should be noted that the MFPs 2, 3 have similar constitutions except data stored in an HDD 220, and therefore the drawing of the MFP 3 is omitted.

The MFP 2 comprises a CPU 211, ROM 212, RAM 213, NVRAM 214, real-time clock (RTC) 215, LAN interface 216, control panel 217, scanning unit 218, printing unit 219, and HDD 220. The CPU 211 generally controls each unit inside the MFP 2. The ROM 212 stores control program or fixed data to be executed by the CPU 211. The RAM 213 has a working area for use in executing the control program stored in the ROM 212. The NVRAM 214 is a nonvolatile memory, and stores various types of setting data and the like. The RTC 215 produces present time information which is information indicating year, month, day, day of the week, hour, minute, second. The LAN interface 216 is used for connection to the LAN 1. The control panel 217 receives commands from a user, or displays information in accordance with user's demand. The scanning unit 218 reads an image from a draft to produce image data. The printing unit 219 performs printing based on print data received from the outside via the LAN interface 216 or image data produced by the scanning unit 218. The HDD 220 stores various types of data.

The HDD 220 has a working area (WA) 220a for use in performing working concerning image processing, and a recovery area (RA) 220b which backs up data indicating working contents to be stored in the working area of the MFP 3 as storage areas of data. The RA 220b opens to the MFP 3 in order to back up a working area 320a of an RDD 320 of the MFP 3.

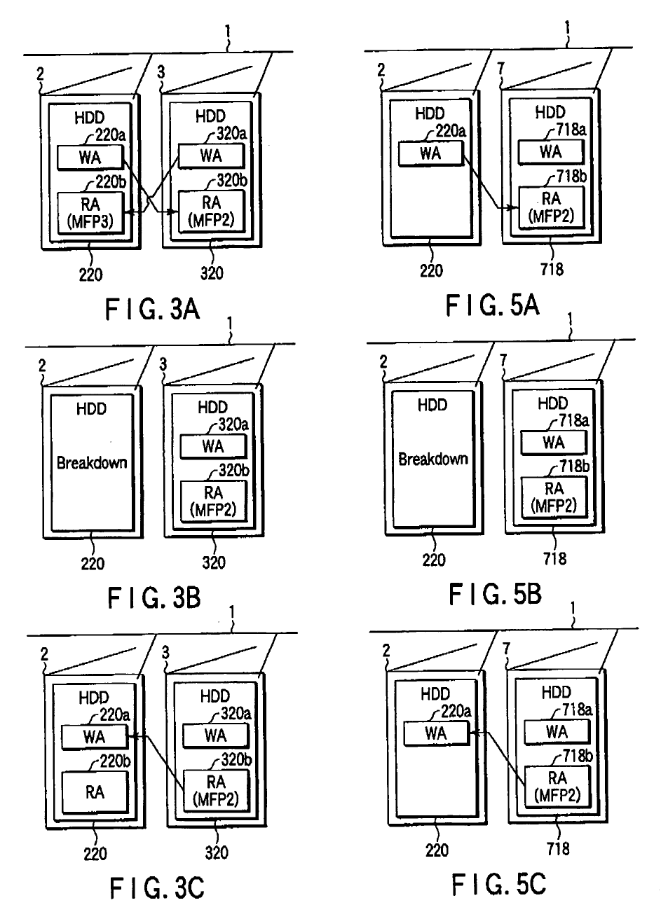

It should be noted that the HOD 320 of the MFP 3 has a working area (WA) 320a for use in performing the working concerning the image processing, and a recovery area (RA) 320b which backs up the data indicating the working contents to be stored in the WA 220a of the MFP 2 as the storage areas of the data. They are shown in FIG. 3A. The RA 320b opens to the MFP 2 in order to back up the WA 220a of the HDD 220 of the MFP 2.

FIG. 3A is a diagram showing a correspondence between storage areas of the HDDs 220, 320 of the MEPs 2, 3 composed in this manner. As described above, the respective HDDs 220, 320 are provided with the WAs 220a, 320a and the RAs 220b, 320b. Moreover, as shown by arrows in the figure, the RA 220b backs up the WA 320a, and the RA 320b backs up the WA 220a.

A case where the HDD 220 of the MFP 2 composed in this manner breaks down will be described with reference to FIG. 3B. In the MFP 2, as shown in FIG. 3B, in case of breakdown or the like of the HDO 220, even when an operation concerning the image processing is accepted, the HDD 220 does not work, and no process can be performed using the HDD 220. However, the data indicating the working contents to be stored in the WA 220a of the MFP 2 is backed up in the RA 320b of the HDD 320 of the MFP 3. Therefore, on accepting an operation concerning image processing, the MFP 2 uses the RA 320b of the HDD 320 of the MFP 3 via the LAN 1, and executes the accepted operation. Thus, the MFP 2 can perform the working concerning image processing, when the HDD 220 breaks down. It should be noted that the data indicating the working contents are additionally written in the RA 320b of the HDD 320.

Subsequently, recovery of the data at the time of replacement of the HDD 220 of the MFP 2, which has broken down, with a new HDD 220 will be described with reference to FIG. 3C. After the replacement of the HOD 220, the MFP 2 accepts a predetermined operation from an operator. Then, the data indicating the working contents, stored in the RA 320b of the HDD 320 of the MFP 3, is copied to the WA 220a of the HDD 220 of the MFP 2. That is, the data indicating the working contents of the MFP 2 is recovered by the WA 220a of the HDD 220. Accordingly, the MFP 2 can perform the working concerning image processing using the HDD 220 in the same manner as in continuous use of the HDD 220. It should be noted that to recover the HDD 220, the data indicating the working contents to be stored in the WA 320a of the MFP 3 may be copied to the RA 220b of the MFP 2.

The backup structure of the data between the MFPs like the MFPs 2, 3 has been described, but the data may be backed up using the PC 7. A structure will be described hereinafter in which the WA 220a of the MFP 2, and the WA 320a of the MFP 3 are backed up using an HDD 718 of the PC 7.

First, an inner structure of the PC 7 will be schematically described with reference to FIG. 4. The PC 7 comprises a CPU 711, ROM 712, RAM 713, RTC 714, LAN interface 715, CD-ROM drive 716, DVD-RAM drive 717, and HDD 718. The CPU 711 generally controls each unit inside the PC 7. The ROM 712 stores control program or fixed data to be executed by the CPU 711. The RAM 713 has a working area for use in executing the control program stored in the ROM 712. The RTC 714 produces present time information which is information indicating year, month, day, day of the week, hour, minute, second. The LAN interface 715 is used for the connection to the LAN 1. The CD-ROM drive 716 is used in reading the data stored in a CD. It should be noted that the PC 7 is capable of reading the data stored in the CD set in the CD-ROM drive 716 and starting by a predetermined operation. The DVD-RAM drive 717 records the data in a DVD-RAM, and reads the data recorded in the DVD-RAM.

The HDD 718 has a working area (WA) 718a which stores various data, a recovery area (RA) 718b which backs up the data indicating the working contents to be stored in the WA 220a of the HDD 220 of the MFP 2, and a recovery area (RA) 718c which backs up the data indicating the working contents to be stored in the WA 320a of the HDD 320 of the MFP 3 as the storage areas of the data. These RAs 718b, 718c open to back up the WA 220a of the MFP 2 and the WA 320a of the MFP 3.

FIG. 5A is a diagram showing a correspondence between the storage areas of the HDD 220 of the MFP 2 and the HDD 718 of the PC 7. It should be noted that in FIGS. 5A to 5C, a correspondence between the storage areas of the HDD 320 of the MFP 3 and the HDD 718 of the PC 7 is omitted from the figures. The HDD 220 of the MFP 2, and the HDD 718 of the PC 7 are provided with the WAs 220a, 718a. Moreover, the HDD 718 of the PC 7 is provided with the RA 718b which backs up the data indicating the working contents to be stored in the WA 220a of the MFP 2 to recover the data.

A case where the HDD 220 of the MFP 2 composed in this manner breaks down will be described with reference to FIG. 5B. In the MFP 2, as shown in FIG. 5B, in case of breakdown or the like of the HDD 220, even when operation concerning image processing is accepted, the HOD 220 does not work, and no process can be performed using the HDD 220. However, the data indicating the working contents to be stored in the WA 220a of the MFP 2 is backed up in the RA 718b of the HDD 718 of the PC 7. Therefore, on accepting an operation concerning image processing, the MFP 2 uses the RA 718b of the HDD 718 of the PC 7 via the LAN 1, and executes the accepted operation. Thus, the MFP 2 can perform the working concerning image processing, when the HDD 220 breaks down. It should be noted that the data indicating the working contents is additionally written in the RA 718b of the HDD 718 of the PC 7.

Subsequently, the recovery of the data at the time of the replacement of the HDD 220 of the MFP 2, which has broken down, with a new HDD 220 will be described with reference to FIG. 5C. After the replacement of the HDD 220, the MFP 2 accepts a predetermined operation from an operator. Then, the data indicating the working contents, stored in the RA 718b of the HDD 718 of the PC 7, is copied to the WA 220a of the HDD 220 of the MFP 2. That is, the data indicating the working contents of the MFP 2 is recovered by the WA 220a of the HDD 220. Accordingly, the MFP 2 can perform the working concerning image processing using the HDD 220 in the same manner as in the continuous use of the HDD 220.

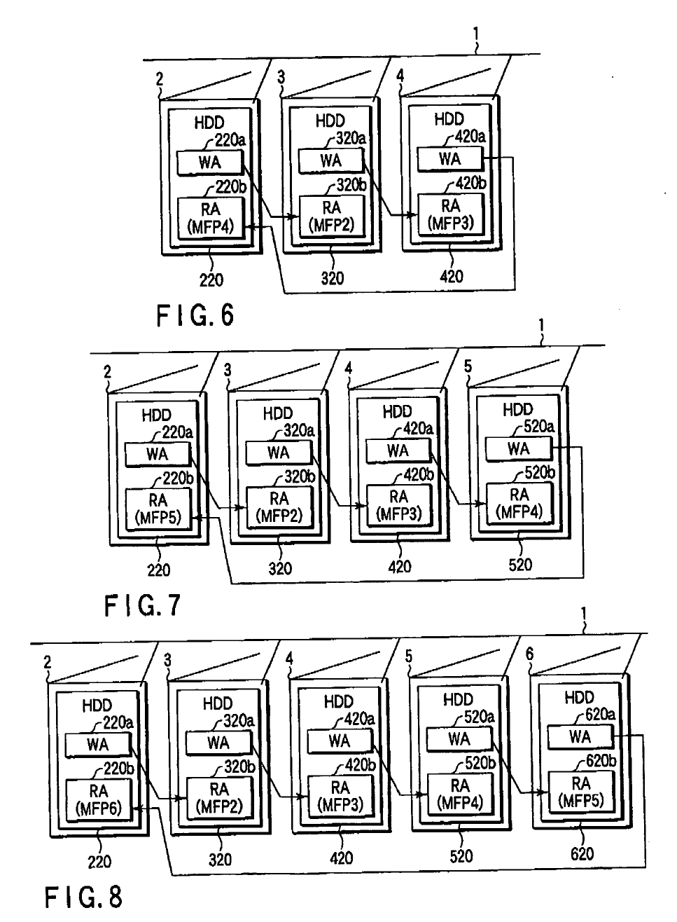

The backups performed with the correspondences between the MFPs 2, 3 and between the MFP 2 and the PC have been described above. However, the present invention is not limited to the correspondences. For example, correspondences described with reference to FIGS. 6 to 13 may be used.

FIGS. 6 to 8 show a correspondence among the storage areas of the HDDs in a case where the MFPs back up one another. FIG. 6 shows three MFPs 2, 3, 4. FIG. 7 shows four MFPs 2, 3, 4, 5. FIG. 8 shows five MFPs 2, 3, 4, 5, 6. Each of the MFPs is provided with a working area (WA), and a recovery area (RA) which backs up the WAs of the other MFPs. In the present embodiment, for ease of understanding the relation for performing the recovery, the MFPs are serially numbered from 2, and the number of an MFP recovered by the MFP is its own MFP number+1. It should be noted that the MFP having a last MFP number is backed up by the MFP having a first MFP number.

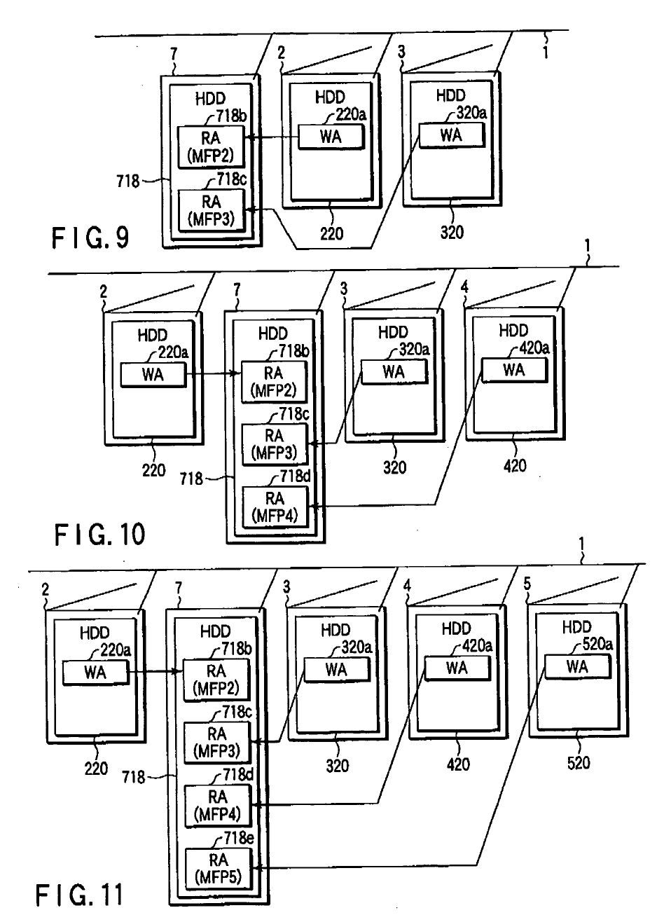

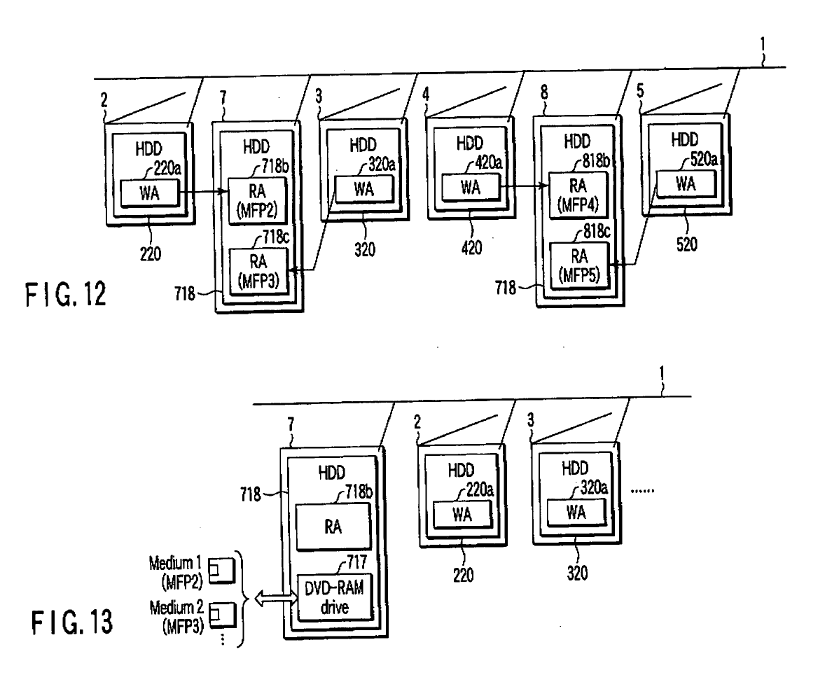

FIGS. 9 to 12 show the correspondences among the storage areas of the HDDs in a case where the WA of the MFP is backed up by the PC. FIG. 9 shows the backup of two MFPs 2, 3 by one PC 7. FIG. 10 shows the backup of three MFPs 2, 3, 4 by one PC 7. FIG. 11 shows the backup of four MFPs 2, 3, 4, 5 by one PC 7. FIG. 12 shows a case where two PCs 7, 8 back up four MFPs 2, 3, 4, 5 every two of them.

FIG. 13 shows a case where DVD-RAMs are prepared beforehand as media corresponding to the MFPs 2, 3, . . . , and the WA of each MFP is backed up by the media. DVD-RAMs (media) 1, 2, . . . corresponding to the respective MFPs are prepared. Moreover, an operator inserts the DVD-RAM into the DVD-RAM drive 717 of the PC 7. A predetermined operation is performed to perform backup copy with respect to the media. For example, when the HOD 220 of the MFP 2 breaks down, the corresponding DVD-RAM 1 is inserted into the DVD-RAM drive 717, and the contents are copied to the RA 718b. Accordingly, when the HDD 220 breaks down, the MFP 2 can perform working concerning image processing using the HDD 718 of the PC. The recovery can be performed utilizing the DVD-RAM1 in a case where the HDD 220 is replaced with a new one. It should be noted that the media for use in the backup may be any large-capacity media capable of recording image data and the like besides the DVD-RAM.

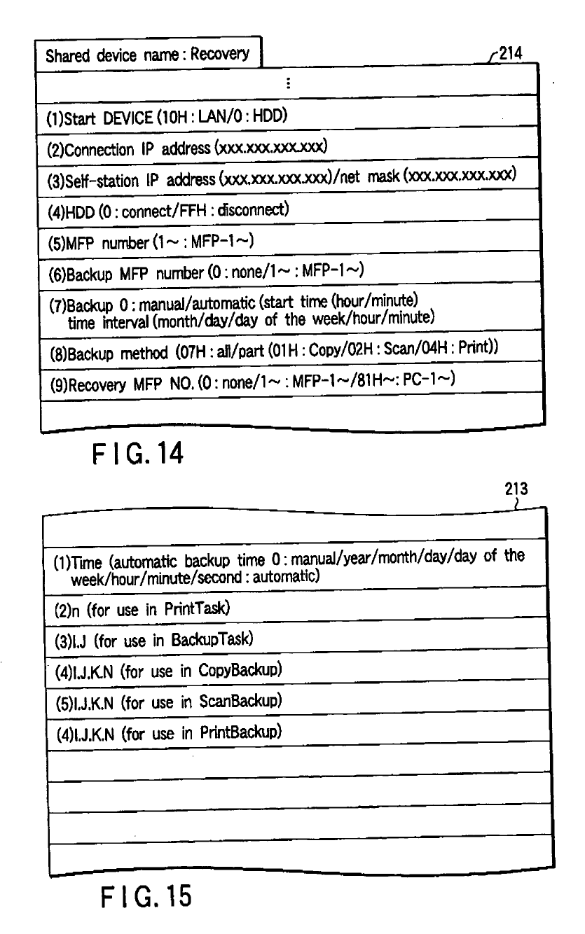

Processes for performing the above-described backups will be described hereinafter in detail. First, contents of data stored in the NVRAM 214, RAM 213, and HOD 220 will be described in detail in a case where the MFPs back up each other. It should be noted that the contents to be stored in the MFP 2 will be described in accordance with examples with reference to FIGS. 14 to 16.

FIG. 14 is a diagram showing details of data to be stored in the NVRAM 214. In the NVRAM 214, areas are secured for setting items “start DEVICE”, “connection IP address”, “self-station IP address/NetMask”, “HDD”, “MFP number”, “backup MFP number”, “backup”, “backup method”, and “Recovery MFP NO.”. In “start DEVICE”, it is set whether to start LAN or HDD. In “connection IP address”, an address for the connection to the LAN 1 is set. In “self-station IP address/net mask”, an address on the LAN 1 is set. In “HDD”, it is set whether the HDD 220 is connected or disconnected. In “MFP number”, an inherent number to be given to the MFP is set. In “backup MFP number”, the MFP number of the MFP which backs up the data of its own HDD 220. In “backup”, it is set whether the operator operates the control panel 217 to manually perform the backup, or the backup is automatically performed at a predetermined start time or predetermined time interval. In “backup method”, it is set whether to back up all or a part of the working area (WA) 220a. To back up a part of the WA 220a, for example, “Copy”, “Scan”, or “Print” is selected. They show areas in the WA 220a to be stored in the HDD 220, when each operation is performed. In “Recovery MFP NO.”, the MFP number of the MFP to be backed up for the recovery is set. It should be noted that a recovery name is automatically set as a file name, when remote access is performed as described later.

FIG. 15 is a diagram showing details of data to be stored in the RAM 213. In the RAM 213, areas for storing settings of items “Time”, “n”, “I, J”, three “I, J, K, N” are formed. In “Time”, a time for performing the automatic backup is set. It is to be noted that “0” is set in a case where the operator manually performs the backup. Variables “n”, “I, J”, three “I, J, K, N” are used in processes described later: “n” is used in a print process; and “I, J” is used in a backup process. Three variables “I, J, K, N” are used in a copy backup process, a scan backup process, and a print backup process, respectively.

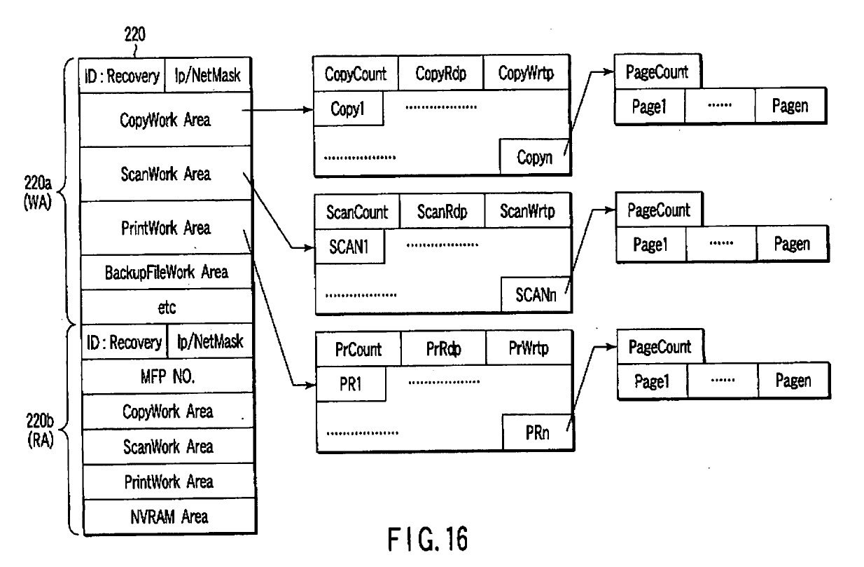

FIG. 16 is a diagram showing contents of data to be stored in the HDD 220. The HDD 220 has the working area (WA) 220a and the recovery area (RA) 220b as described above.

First, the WA 220a will be described. A value indicating “Recovery” falls in an area indicating ID. Values indicating an IP address on the LAN 1 and a net mask are stored in “IP address/NetMask”. A copy work area is a working area for use at the time of copying. This copy work area is further divided into areas “Copy1” to “CopyN”. The areas “Copy1” to “CopyN” are ring buffers using “CopyCount”, “CopyRdp”, “CopyWrtp” as pointers. Further in directories of the respective areas “Copyl” to “CopyN”, pages are shown in a page count. Moreover, page data of a unit to be copied is stored in each of areas “Pagel” to “Pagen”. The data is printed in this order during the copying. A scan work area is an area to store scanning data at the time of scanning. Furthermore, a print work area is an area to store printing data at the time of network printing. As shown, each of the areas has a structure similar to that of the copy work area. A backup file work area and the like are secured as working areas for the backup.

Next, the RA 220b will be described. In the RA, in addition to ID, Ip/NetMask, copy work area, scan work area, and print work area, an area to store MFP NO., and an area to store the contents of the NVRAM 214 are secured. Therefore, in the RA 220b, the WA of the HDD of the MFP corresponding to the MFP NO. is backed up. For example, when the MFP 3 is set as the MFP NO., the MFP 2 backs up the contents stored in the WA 320a of the MFP 3 in the RA 220b.

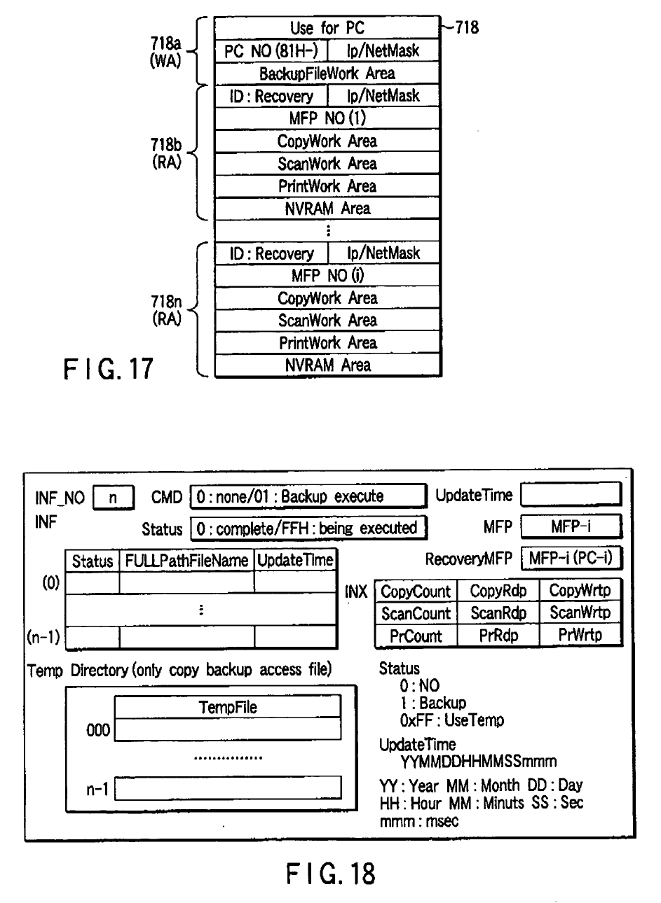

Next, contents of data stored in the HDD 718 will be described in a case where the contents of the WAs of the MFP 2, . . . are backed up by the PC 7. FIG. 17 is a diagram showing the data stored in the EDD 718. The HDD 718 has the WA 718a, RA 718b, . . . , 718n. It should be noted that the RAs are configured to be disposed as many as MFPs to be backed up. The WA 718a is provided with an area indicating an ID number of the PC, an area to store IP/NetMask, and a backup file work area. In each of the RA 718b, . . . , 718n, in addition to ID, Ip/NetMask, copy work area, scan work area, and print work area, an area to store MWP NO., and an area to store the contents of the NVRAM (e.g., in case of the MFP, the NVRAM 214) are secured. It should be noted that a plurality of RAs are secured as many as permitted by a storage area of the HDD 718. Accordingly, the number of PCs which back up the WAs of the MFP 2, . . . on the LAN 1 can be reduced.

FIG. 18 is a table showing details of the backup file work area in a case where the contents of the WA are backed up with respect to the MPPs or the PC. In “command (CMD)” a status for executing a remote command is stored. In “Update Time”, an update time is stored. In “MFP”, the MFP number of the MFP in which the contents of its own WA are backed up is stored. In “Recovery MFP”, the MFP number (or the PC number) of another MFP that backs up for recovery is stored. In “INX”, ring pointers (CopyCount/CopyRdp/CopyWrtp/ScanCount/ScanRdp/ScanWrtp/PrCount/Prkdp/PrWrtp) for working buffers at the time of Copy/Scan/Print are stored. In “INF_NO”, the number of backup files is stored. In “INF”, information of the backup file is stored. In this “INF”, “Status” indicating a status, “FULL Path File Name” for storing file names, and “Update Time” for storing the update time are input. Furthermore, “Temp Directory” is used as an area for temporarily copying an update file in a case where the file is generated during the backup in order to permit the updating.

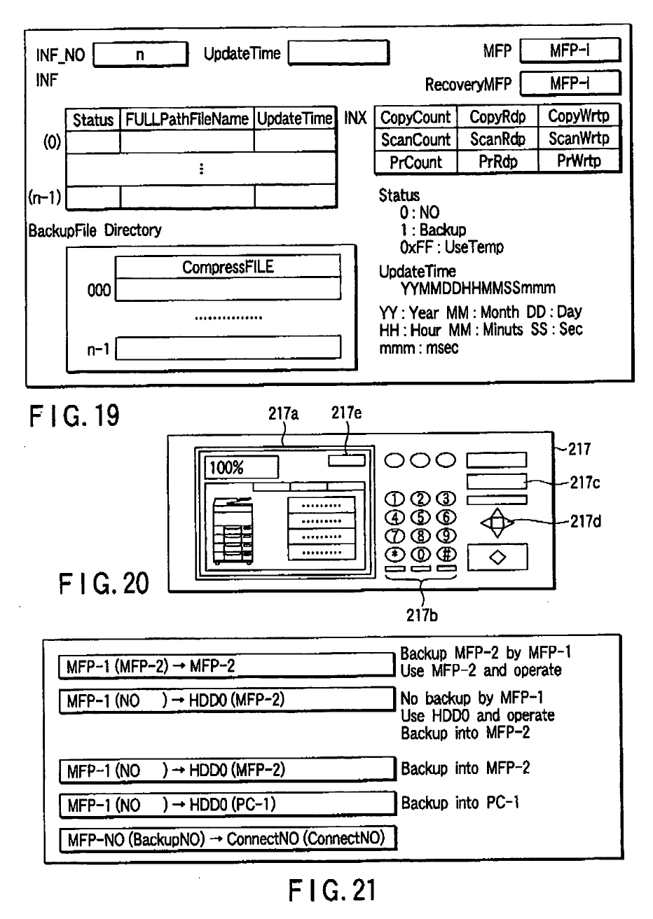

FIG. 19 is a diagram showing details of the backup file work area in a case where the WA of the MFP is backed in the media. In “Update Time”, the update time is stored. In “MFP”, the MFP number of the MEP in which the contents of its own WA are backed up is stored. In “Recovery MFP”, the MFP number of another MFP that backs up for recovery is stored. In “INX”, ring pointers (CopyCount/CopyRdp/CopyWrtp/ScanCount/ScanRdp/ScanWrtp/PrCount/PrRdp/PrWrtp) for working buffers at the time of Copy/Scan/Print are stored. In “INFTNO”, the number of backup files is stored. In “INF”, the information of the backup file is stored. In this “INF”, “Status” indicating a status, “FULL Path File Name” for storing file names, and “Update Time” for storing the update time are input. Furthermore, in “Backup File”, the file to be backed up is compressed/stored. This compressed/stored file is stored by the file number corresponding to an index number of “INF NO.”.

FIG. 20 is a diagram showing the control panel 217. The control panel 217 is provided with a display section 217a, ten keys 217b, an HDD recovery mode key 217c for use in recovering the HDD 220, cursor moving keys 211d for moving a cursor and the like.

FIG. 21 shows contents displayed on a part 217e of the display section 217a. A backup display is performed on the part 217e of the display section 217a during execution of the backup. In this backup display, as shown, “MFP-NO(BackupNO)→ConnectNO(Connect NO)” is displayed. “MFP-NO” indicates its own MFP number. “(Backup NO)” indicates the MFP number stored in the RA of the HDD. “Connect NO” indicates the number which is connected/executed as the HDD. That is, “Connect NO” indicates the HDD number in a case where the HDD is its own HDD 220, and the MEP number of the MFP having the HDD in a case where the HDD is a remote HDD connected via the LAN 1. “(ConnectNO)” indicates the MFP number of the MFP which backed up the WA of the HDD.

A case where the HDD 220 of the MFP 2 breaks down and the broken HDD 220 is replaced with a normal HDD 220 will be described hereinafter.

First, a case where two MFPs 2, 3 back up each other as shown in FIG. 3A will be described.

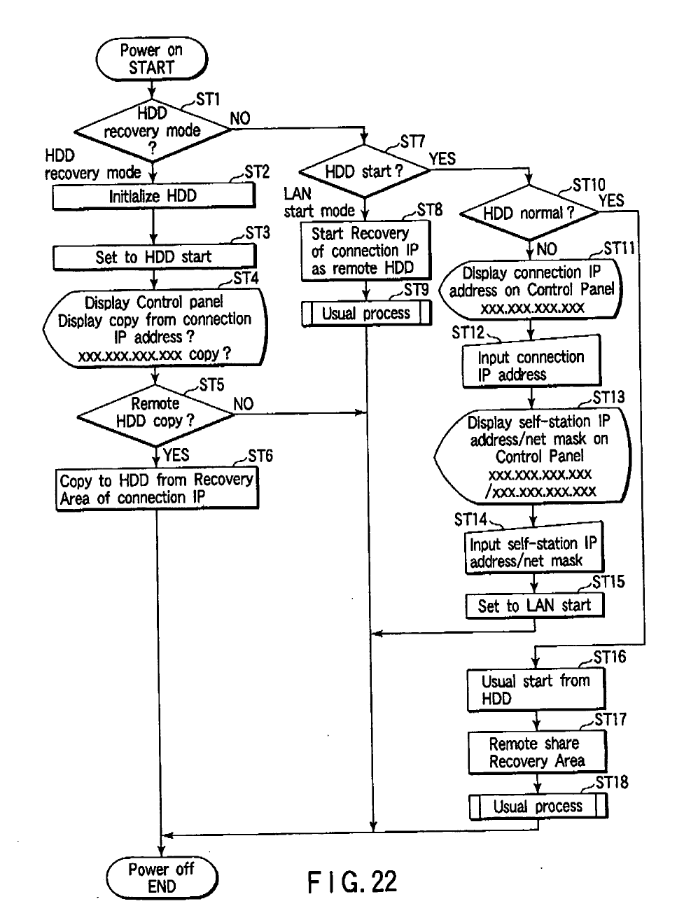

FIG. 22 is a flowchart showing an operation procedure of the MFP 2. If the HDD 220 breaks down, an operator turns off the power of the MFP 2, and replaces the broken HDD 220 with a normal HDD 220. Moreover, to recover the contents stored in the HDD 220, the operator pushes the HDD recovery mode key 217c on the control panel 217 at a time when the power is turned on. Accordingly, the CPU 211 starts up the MFP 2 in an HDD recovery mode (ST1). In this HDD recovery mode, after initializing the HDD 220 (ST2), the CPU 211 sets a start device of the NVRAM 214 to the HDD 220 (ST3). Moreover, the CPU 211 displays a start IP address of the NVRAM 214 on the control panel 217 (ST4), and accepts selection as to whether or not to copy from a connection IP address (ST5). If copying is selected (YES in ST5), the CPU 211 is remote-connected to the connection IP address, and executes a remote HDD copy to copy the contents of the recovery area 320b to the WA 220a of the new HDD 220 (ST6). After the copying, the CPU 211 turns off the power to end the HDD recovery mode. Accordingly, the contents of the broken HDD 220 are recovered by the new HDD 220. If copying is not selected (NO in ST5), the CPU 211 turns off the power of the new HDD 220 still in an initialized state to end the HDD recovery mode.

On the other hand, if the power is turned on, the operator has not pressed the HDD recovery mode key 217c (NO in ST1), and the start device of the NVRAM 214 is LAN, the CPU 211 starts up the MFP 2 in the LAN start mode (YES in ST7). Moreover, the CPU 211 operates the RA 320b of the start IP address of the NVRAM 214 as the remote HDD (ST8). Moreover, the CPU 211 executes usual processes (described later) such as copying, scanning, printing and the like (ST9). Moreover, the MFP 2 operates in the LAN start mode until the power is turned off.

Furthermore, if the power is turned on, the operator has not pressed the HDD recovery mode key 217c, the start device of the NVRAM 214 is the HDO 220, and access to the HDD 220 is judged not to be normal (NO in ST10), the CPU 211 performs a switching process to switch to LAN start. That is, the CPU 211 displays the start IP address on the display section 217a of the control panel 217 (ST11), and accepts an input of the connection IP address (ST12). Next, the CPU 211 displays a self-station IP address and net mask on the display section 217a of the control panel 217 (ST13), and accepts an input of the self-station IP address and net mask (ST14). Accordingly, the CPU 211 sets the start device of the NVRAM 214 to the LAN (STl5), and the power is turned off. When the power is next turned on, the MFP 2 starts in the above-described LAN start mode. It should be noted that restart may be automatically performed. If the CPU 211 judges that the access to the HDD 220 is normal (YES in ST10), the set RA 320b is remote-shared (ST16). Moreover, the CPU 211 executes usual processes such as copying, scanning, printing and the like (ST9).

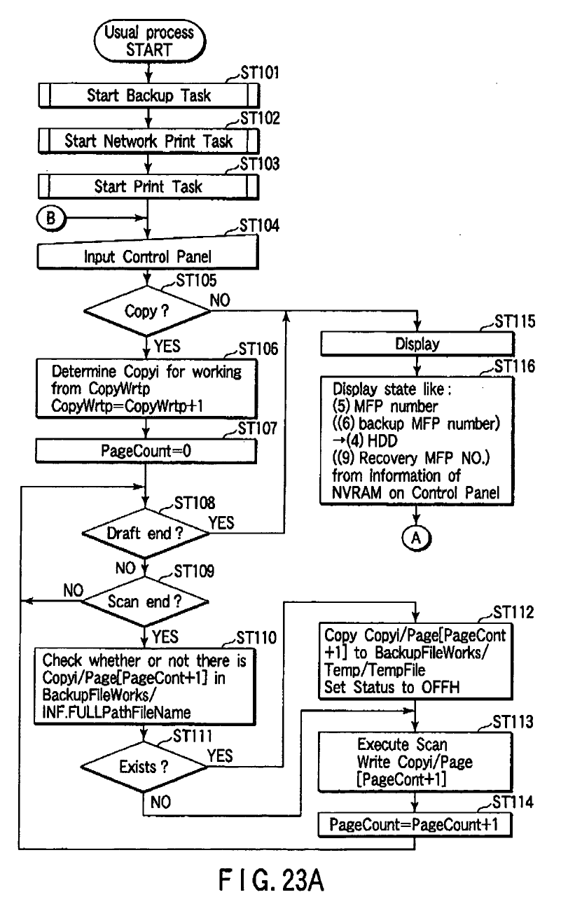

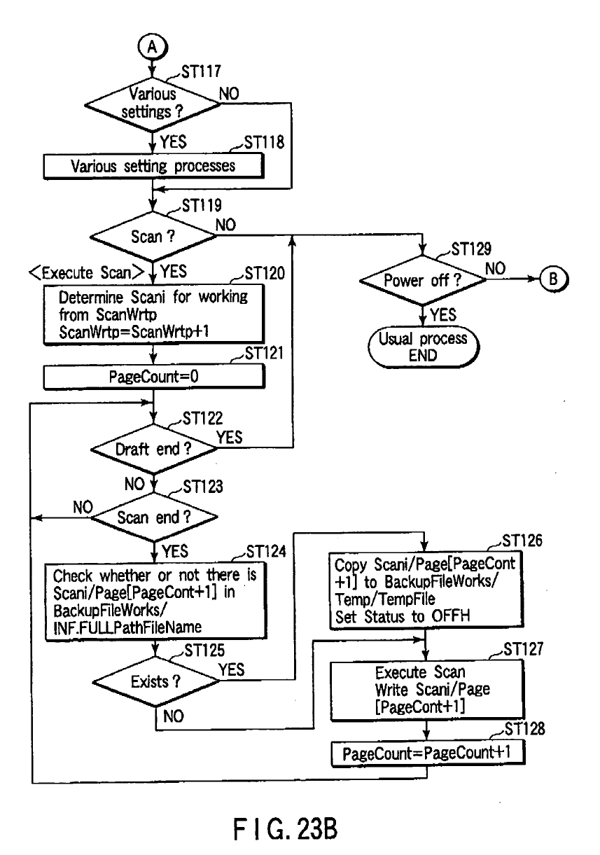

FIGS. 23A and B are flowcharts showing a procedure of the usual process of the CPU 211. First, a backup task (ST101), a network task (ST102), and a print task (ST103) are started. Details of these processes will be described later. Moreover, the CPU 211 accepts an input from the control panel 217 (ST104), and executes each process until the power is turned off.

If Copy is selected (YES in ST105), the CPU 211 determines Copyi for working from CopyWrtp, and updates CopyWrtp=CopyWrtp+1 (ST106). Moreover, the CPU 211 sets PageCount to “0” (ST107), successively scans and inputs drafts each page from Page[1] into Copyi for working, and counts the number of draft sheets by a page counter (ST108 to ST114). On judging that the drafts have ended (YES in ST108), the CPU 211 displays on the part 217e of the display section 217a (ST11S). As shown in FIG. 21, the MFP number (backup MFP number)→HDD (MFP number for recovering) are displayed (ST116).

If various settings are selected (YES in ST117), the CPU 211 performs various setting processes to set accepted various settings to the NVRAM 214 (ST118). The various setting processes will be described later.

If Scan is selected (YES in ST119), the CPU 211 determines Scani for working from ScanWrtp, and updates ScanWrtp=ScanWrtp+1 (ST120). Moreover, the CPU 211 sets PageCount to “0” (ST121), successively scans and inputs drafts each page from Page [ ] into Scani for working, and counts the number of draft sheets by a page counter (ST122 to ST128). On judging that the drafts have ended (YES in ST122), the CPU 211 ends the scanning process. The CPU 211 stands by in order to perform the usual process until accepting the input to turn off the power (YES in ST129).

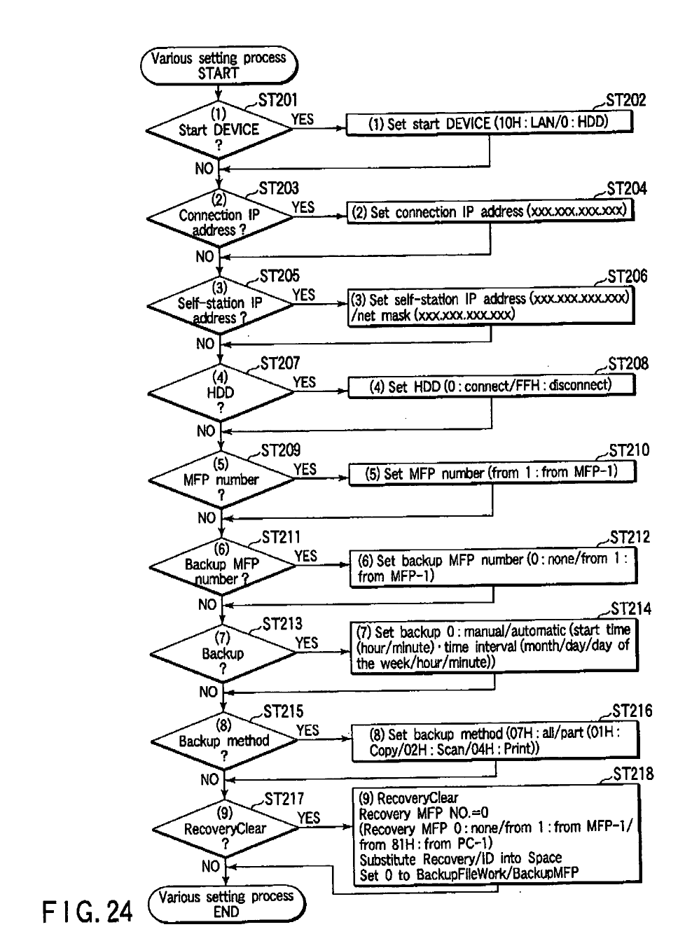

FIG. 24 is a flowchart showing various setting processes for setting the NVRAM 214. If “start DEVICE” is selected (YES in ST201), the CPU 211 sets the start device (ST202). If “connection IP address” is selected (YES in ST203), the CPU 211 sets the connection IP address (ST204). If “self-station IP address” is selected (YES in ST205), the CPU 211 sets the self-station IP address/NetMask (ST206). If “HDD” is selected (ST207), the CPU 211 sets connection or disconnection of the HDD (ST208). If “MFP number” is selected (ST209), the CPU 211 sets the MFP number (ST210). If “backup MFP number” is selected (ST211), the CPU 211 sets the backup MFP number (ST212). If “backup” is selected (ST213), the CPU 211 sets whether the backup is manually or automatically performed (ST214). If “Backup method” is selected (ST215), the CPU 211 sets the backup method (ST216). If “Recovery Clear” is selected (ST217), the CPU 211 clears the recovery area (ST218).

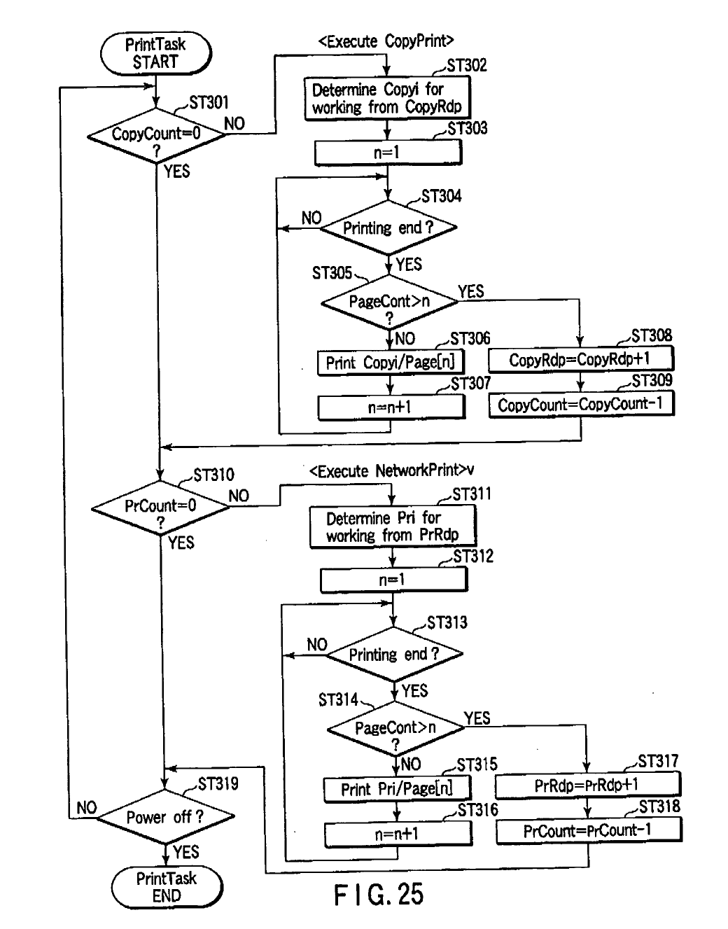

FIG. 25 is a flowchart showing a print task. If CopyCount is not “0”, that is, when there is copy printing data (NO in ST301), the CPU 211 determines Copyi for print working from CopyRdp (ST302), and sets variable n to “1” (ST303). Moreover, the CPU 211 successively prints each page from Page[1] in Copyi for working, and prints the page to PageCount page (ST304 to ST307). Moreover, after the end of the printing, the CPU 211 updates each counter CopyRdp, CopyCount (ST308, ST309).

If PrCount is not “0”, that is, when there is printing data of Network Print (NO in ST310), the CPU 211 determines Pri for print working from PrRdp (ST311), and sets variable n to “1” (ST303). Moreover, the CPU 211 successively prints each page from Page[1] in Pri for the print working, and prints the page to PageCount page (ST313 to ST316). Moreover, after the end of the printing, the CPU 211 updates each counter PrRdp, PrCount (ST317, ST318).

The CPU 211 repeats monitoring CopyCount, PrCount until the power is turned off (YES in ST319).

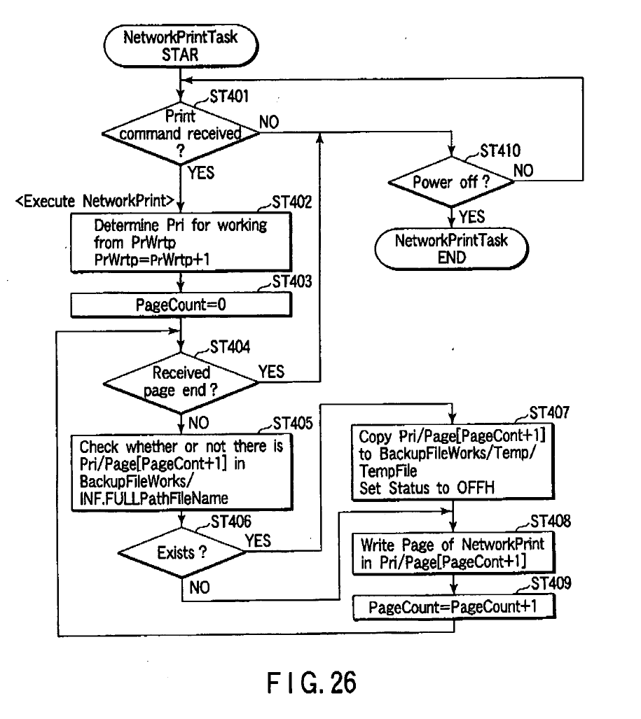

FIG. 26 is a flowchart showing a network print task. When receiving a network print command (YES in ST401), the CPU 211 determines Pri for working from PrWrtp (ST402), and sets PageCount to “0” (ST403). Moreover, the CPU 211 converts network print data received from Page[1] into page data, and inputs each page into Pri for working to update PageCount (ST404 to ST410). The CPU 211 performs this process until it judges that the received pages have ended (NO in ST404), and repeats reception until the power is turned off.

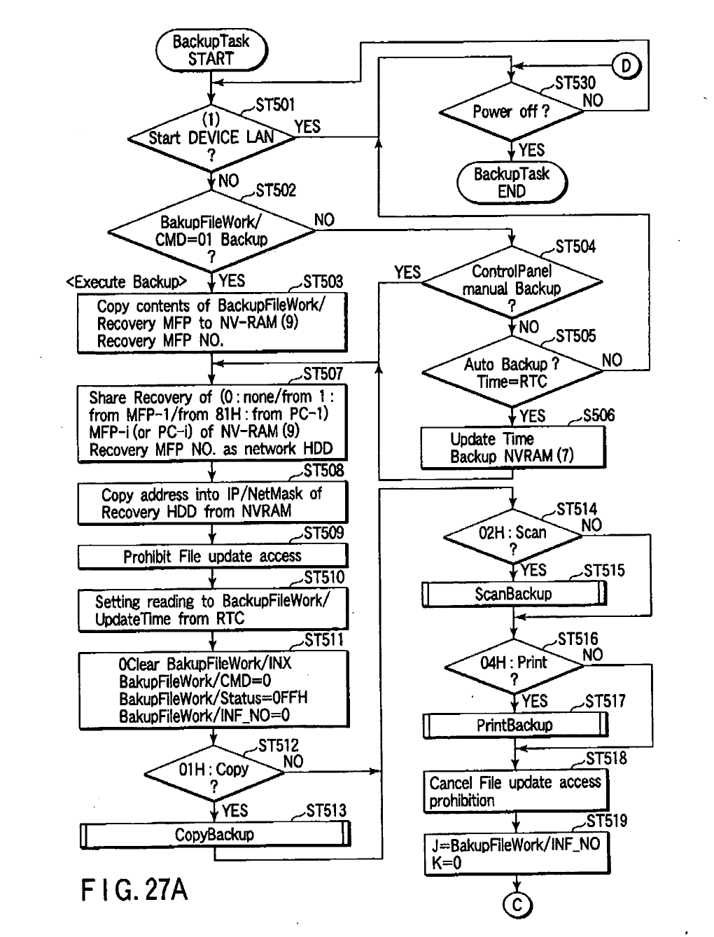

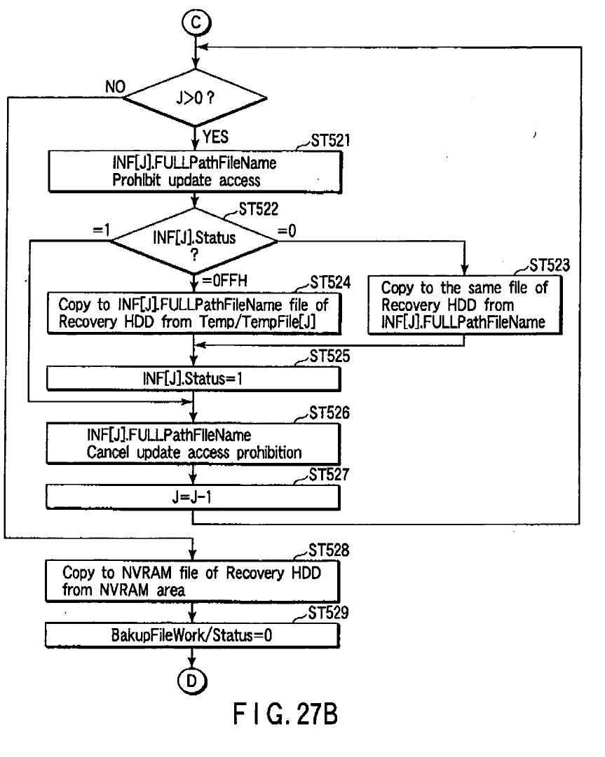

FIGS. 27A and 27B are flowcharts showing the backup task. If the start is LAN start (YES in ST501), the CPU 211 does not perform the backup. If the start is not LAN start (NO in ST501), the CPU 211 performs the backup.

If CMD=1 of Backup File Work (i.e., when there is a backup request from remote, YES in ST502), the CPU 211 copies the contents of “Recovery MFP” of Backup File Work to “Recovery MFP NO.” of the NVRAM 214 (ST503). When the copying is performed, manual backup is designated in the control panel 217, and there is an instruction for the backup (YES in ST504) or automatic backup is designated, a designated time is reached (YES in ST505), and the designated time is updated (ST506), the stored contents of the WA 220a are backed up in the RA 320b of the HDD 320 of the set MFP 3. First, the CPU 211 shares “Recovery” (ST507), copies the address to IP/net mask of Recovery HDD (ST508), prohibits update access to the file (ST509), and initializes the backup file work area (ST510, ST511).

Moreover, if Backup of Copy is designated (YES in ST512), the CPU 211 executes a copy backup process to store file information in INF of Backup File (ST513). If Backup of Scan is designated (YES in ST514), the CPU 211 executes a scan backup process to store file information into INF of Backup File (ST515). If a print backup process is designated (YES in ST516), the CPU 211 executes the print backup process to store file information into INF of Backup File (ST517).

After canceling prohibition of update access to the file (ST518), the CPU 211 performs backup copy of actual file based on the file information of INF of Backup File (ST519 to ST527). Moreover, finally the CPU 211 performs the backup copy of the area of the NVRAM 214 (ST528), Status=0 is set with respect to Backup File Work (ST529). The CPU 211 performs the backup at a timing designated in ST504 or ST505 until the power is turned off (YES in ST530).

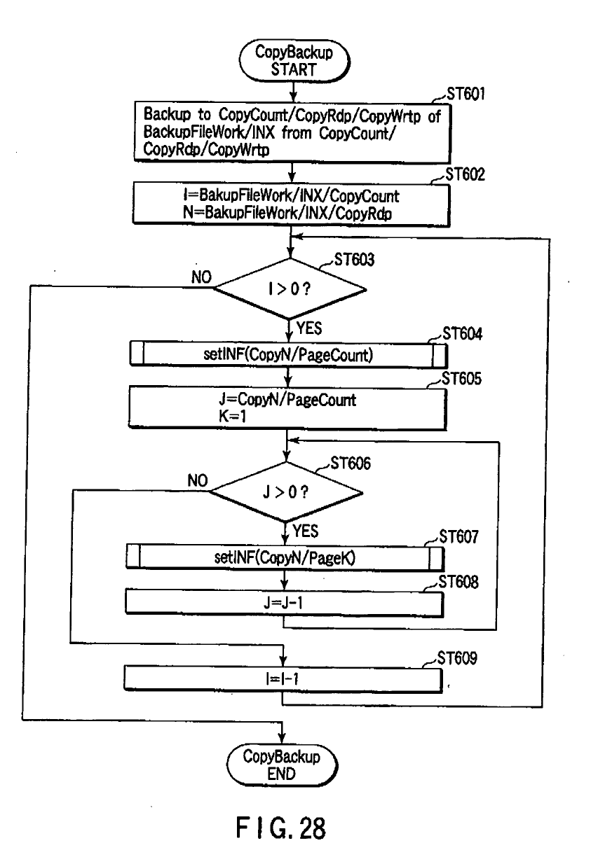

FIG. 28 is a flowchart showing the above-described copy backup process. The CPU 211 backs up the contents of CopyCount/CopyRdp/CopyWrtp into CopyCount/CopyRdp/CopyWrtp of INX of Backup File Work (ST601). Moreover, the CPU 211 substitutes all file information in Page[1] to Page[PageCount] in directories Copy[CopyRdp] to Copy[CopyWrtp] into INF (ST602 to ST609).

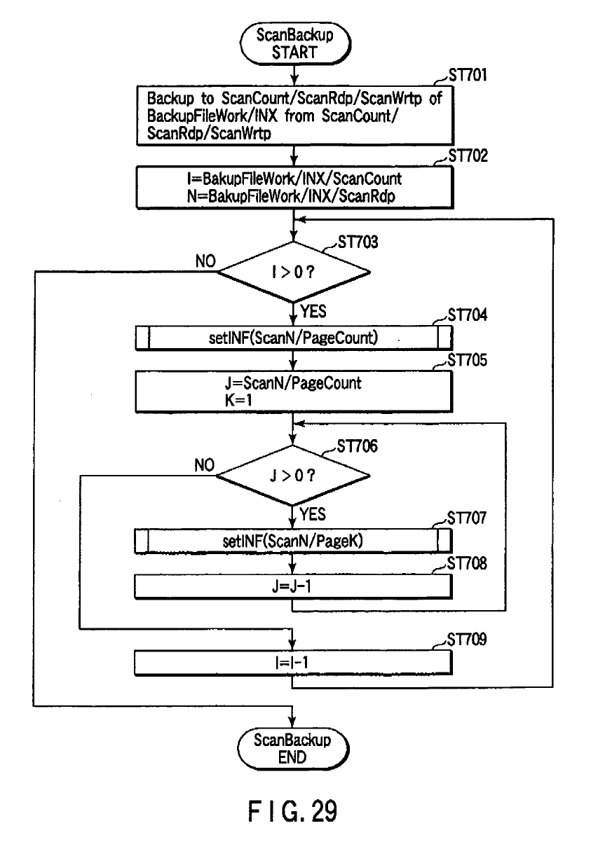

FIG. 29 is a flowchart showing the above-described scan backup process. The CPU 211 backs up the contents of ScanCount/ScanRdp/ScanWrtp into ScanCount/ScanRdp/ScanWrtp of INX of Backup File Work (ST701). Moreover, the CPU 211 substitutes all file information in Page[1] to Page[PageCount] in directories Scan[ScanRdp] to Scan[ScanWrtp] into INF (ST702 to ST709).

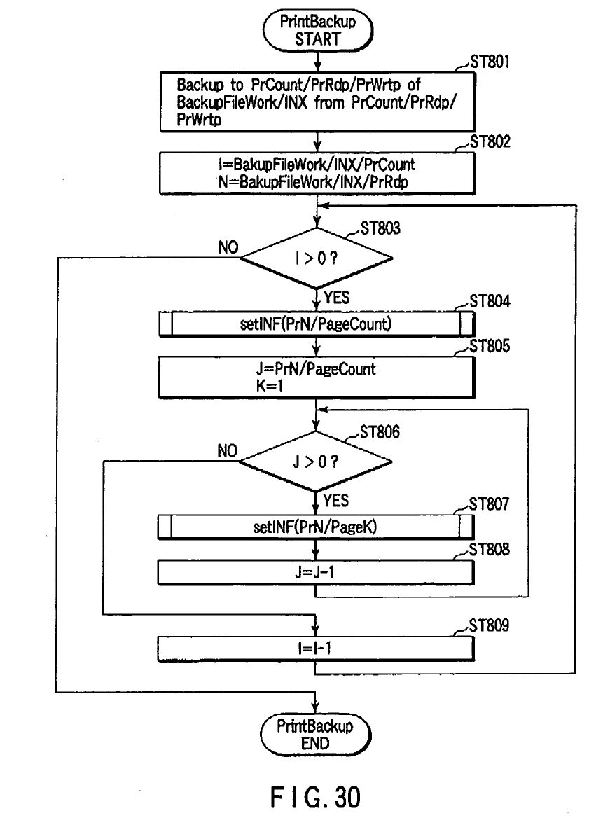

FIG. 30 is a flowchart showing the above-described print backup process. The CPU 211 backs up the contents of Prcount/PrRdp/PrWrtp into Prcount/PrRdp/PrWrtp of INX of Backup File Work (ST801). Moreover, the CPU 211 substitutes all file information in Page[1] to Page[PageCount] in directories Pr[ScanRdp] to Pr[ScanWrtp] into INF (ST802 to ST809).

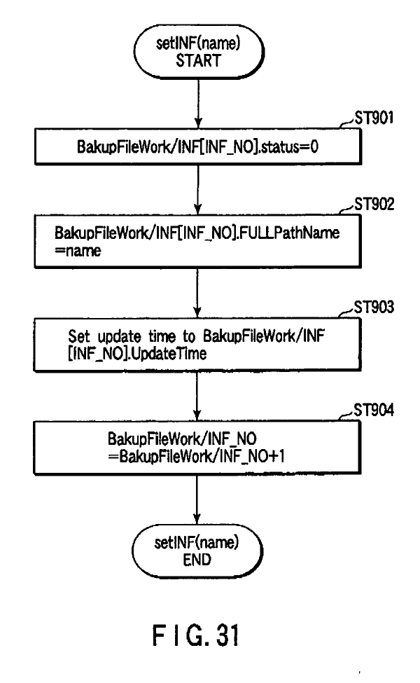

FIG. 31 is a flowchart showing a setINF process to set a file name as described with reference to FIGS. 28 to 30. This process is realized by execution of a module for setting a file name (name) to “INF” of Backup File Work by the CPU 211. The CPU 211 sets INF[INF_NO].Status=0 (ST901). Moreover, the CPU 211 sets the file name as INF[INF_NO].FULLpath Name=name (ST902). The CPU 211 sets the update time of the name to INF[INF_NO].update Time (ST903). Finally, the CPU 211 sets INF_NO=INF_NO+1 to update the counter (ST904).

When this process is performed, the MFP 2 can back up the WA 320a of the MFP 3. The MFP 2 is capable of allowing the MFP 3 connected to the LAN 1 to back up the WA 220a. Therefore, even if the HDD 220 of the MFP 2 breaks down, the operator can perform the working concerning the image processing using the RA 320b of the MPP 3 that has backed up the HDD 220 as a remote HDD. After replacing the broken HOD 220 with the new HDD 220, the operator can recover the WA 220a of the HDD 220 of the MFP 2 using the RA 320b of the MFP 3 that has backed up the WA.

Next, a process will be described in a case where the WA 220a of the MFP 2 is backed up using the PC 7.

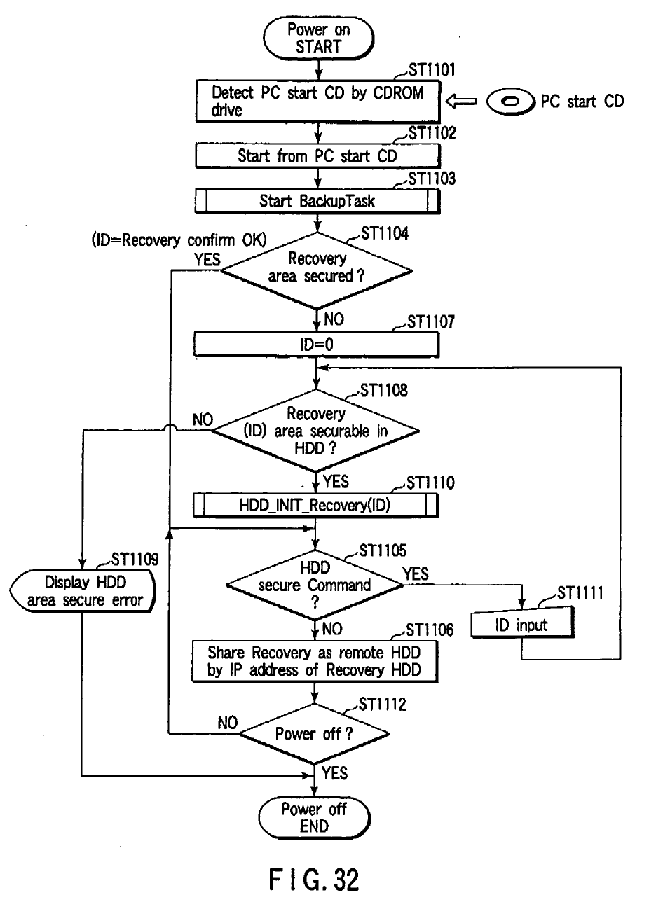

FIG. 32 is a flowchart showing an operation procedure of the PC 7. The operator inserts a CD for starting the PC into the CD-ROM drive 716 of the PC 7. Accordingly, the CPU 711 detects the CD (ST1101), and starts up the PC 7 using the CD inserted in the CD-ROM drive 716 (ST1102). A control program for backing up the WA of the MFP using the PC 7 is stored on the CD. Moreover, the CPU 711 first starts BackupTask (ST1103). Furthermore, if the CPU 711 judges that the recovery area (RA) 718b is already secured in the HDD 718 (confirm by ID=Recovery, YES in ST1104) and judged that the command is not an HDD securing command to secure a storage area of the HDD 718 (YES in ST1105), the CPU starts up by the IP address/net mask set to the RA 718b of the HDD 718, and operates in such a manner as to be capable of sharing/executing the RA 718b using the RA as the remote HDD (ST1106).

Moreover, if the CPU 711 judges that the RA 718b is not secured in the HDD 718 (NO in ST1104), ID is set to “0” (ST1107), and the RA is newly secured. At this time, the CPU 711 first checks whether or not there is an area for securing the RA 718b in the HDD 718, and when the area cannot be secured (NO in ST1S06), an HDD area securing error is displayed on the PC screen to end with the error (ST1109). When the RA 718b can be secured in the HOD 718 (YES in ST1108), an HDD_INIT_Recovery process described later is performed (ST1110), and it is judged whether or not the HDD securing command has been received (ST1105). If it is judged that the command is not the HDD securing command, the CPU 711 starts up by the IP address/net mask set in the process of the step ST110, and operates in such a manner that the RA 718b can be shared/executed as the remote ROD. If the command is judged to be the HDD securing command, the CPU 711 accepts the input of ID (ST1111), and thereafter performs a process to check whether or not there is an area for securing the RA 718b in the HDD 718 (ST110B). The CPU 711 operates in such a manner that the RA 718b can be shared/executed as the remote HDD until the power is turned off (ST1112).

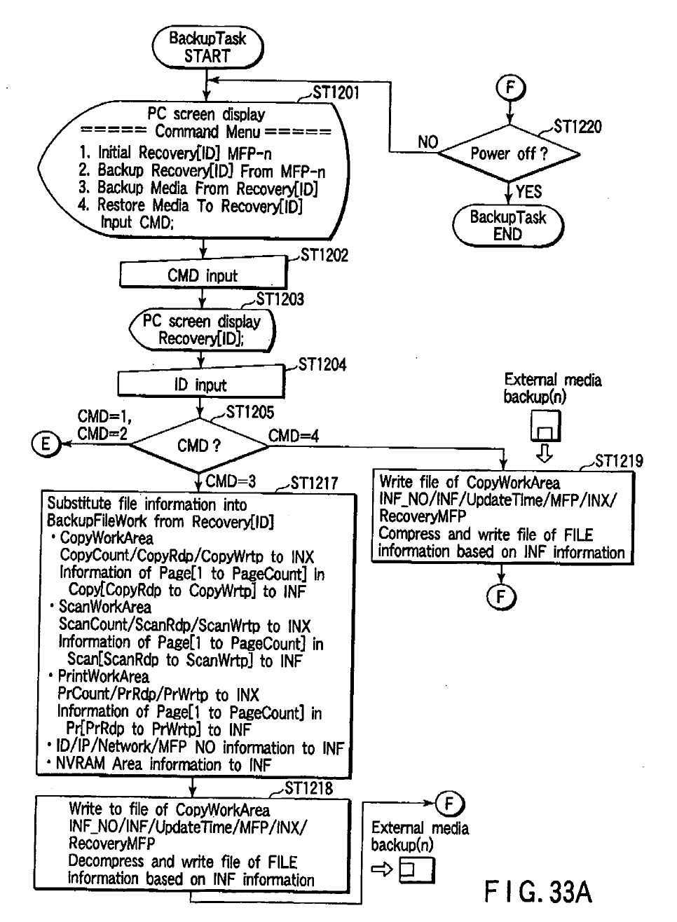

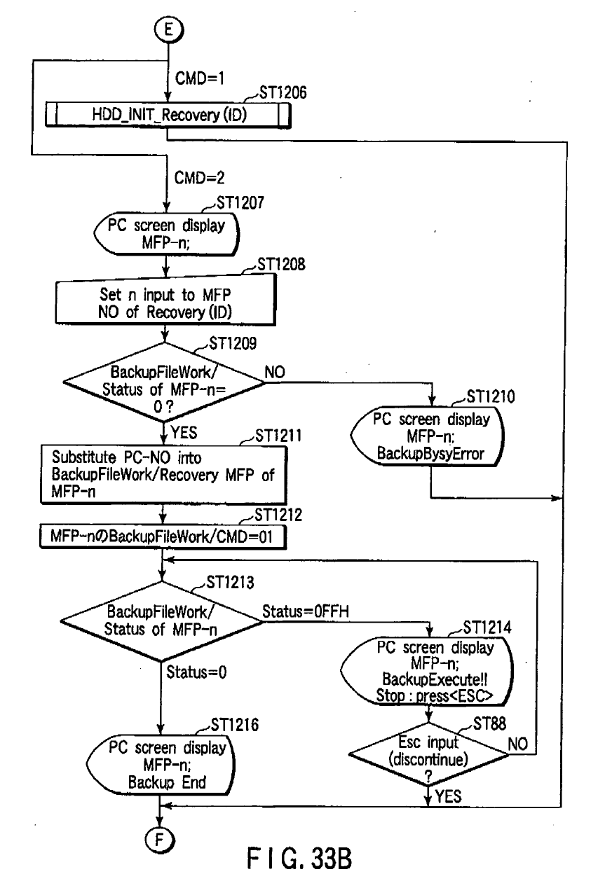

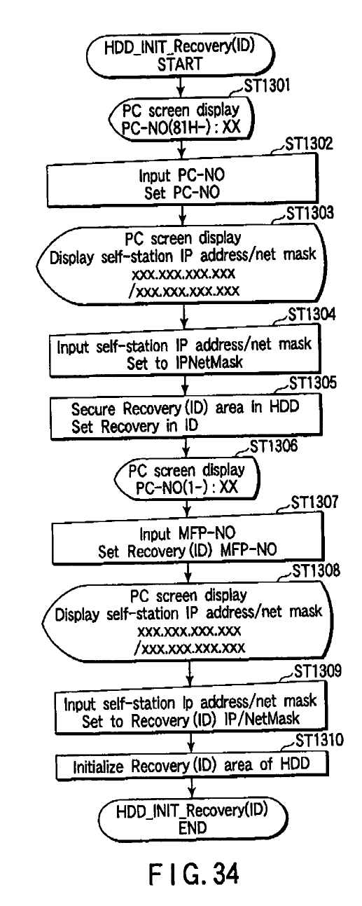

FIGS. 33A and B are flowcharts showing the above-described backup task. The CPU 711 displays a command menu on the PC screen (ST1201). For example, the following four commands are displayed. A first command (CMD1) is a command for performing a process to prepare Recovery[ID] for MFP_n in an initial state from the HDD 718. A second command (CM02) is a command for performing a process to back up the data of MFP_n into Recovery[ID]. A third command (CMD3) is a command for performing a process to back up data into external media from Recovery(ID). A fourth command (CMD4) is a command for performing a process to restore the data into Recovery[ID] from the external media into which the data is backed up. Moreover, on accepting the input of the command (ST1202), the CPU 711 displays that Recovery(ID) is to be accepted on the PC screen (ST1203), and accepts the ID input (ST1204). Moreover, the CPU 711 performs the following process in response to the input command (ST1205).

If CMD1 is input, the CPU 711 executes the HOD_INIT-Recovery(ID) process (ST1206).

If CMD2 is input, the CPU 711 displays that the input of the MFP number is to be accepted on the PC screen (ST1207), and sets an input accepted number to MEP NO. of Recovery(ID) (ST1208). Moreover, the CPU 711 judges whether or not the status of Backup File Work is “0” (ST1209). If the status is not “0”, an error is displayed on the PC screen (ST1210). If the status is “0”, the PC number is substituted into Recovery MFP of Backup File Work (ST1211). Subsequently, the CPU 711 judges whether the status of Backup File Work of MFP to which the number has been set is “0” or “OFPHI” (ST1213). If the status is “OFFH”, the CPU 711 displays that the backup is being executed and the backup is stopped by the input of an “ESC” key (ST1214). Moreover, the CPU 711 monitors whether or not the input of the “ESC” key has been accepted until the status is judged to be “0” (ST1215). If the input of the “ESC” key is accepted, the backup is stopped. If the input of the “ESC” key is not accepted, and the status turns to “0”, the CPU 711 displays that the backup ends on the PC screen (ST1216).

If CMD3 is input, the CPU 711 substitutes the file information into Backup File Work from Recovery(ID) (ST1217), and the file of the file information is compressed and written based on the substituted INF information (ST1218). Accordingly, the contents stored in the WA 220a of the MFP 2 can be backed up in DVD-RAM which is an external medium.

If CMD4 is input, the CPU 711 decompresses the file of the file information based on the INF information, and writes the file into Recovery(ID) (ST1219). Accordingly, the contents stored in the WA 220a of the MFP 2 and backed up by the DVD-RAM which is the external medium can be restored into the RA 718b.

The CPU 711 accepts the input of the command until the power is turned off (YES in ST1220).

FIG. 34 is a flowchart showing the above-described HDD_INIT_Recovery process. The CPU 711 displays that an input of a PC number (PC-NO) is to be accepted on the PC screen (ST1301), accepts the input of the PC number, and sets the PC number (ST1302). Moreover, the CPU 711 displays that an input of self-station IP address/net mask is to be accepted (ST1303), accepts the input of self-station IP address/net mask, and sets the input to IP/Net Mask (ST1304). The CPU 711 secures the RA 718b in the HDD 718, and sets “Recovery” to ID (ST1305). Subsequently, the CPU 711 displays that an input of MFP number (MFP_NO) is to be accepted (ST1306), accepts the input of the MFP number, and sets the MFP number (ST1307). The CPU 711 displays the self-station IP address/net mask on the PC screen (ST1308), accepts an operation from the operator, and sets the self-station IF address/net mask to IP/net mask of Recovery(ID) of the RA 718b (ST1309). Moreover, the RA 718b of the HOD 718 is initialized (ST1310).

By performing this process, the PC 7 backs up the WA 220a of the MFP 2 into the RA 718b of the HDD 718, and the backed-up contents can be recorded in the media. Therefore, even if the HDD 220 of the MFP 2 breaks down, the operator restores the contents stored in the media into the RA 718b of the HDD 718 of the PC 7, and can accordingly perform the working concerning the image processing. After replacing the broken HDD 220, the operator can recover the new HDD 220 of the MFP 2 utilizing the restored contents of the RA 718b.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents thereof.

What is claimed is:

1. An image processing apparatus comprising:
a first memory which stores data indicating working contents concerning image processing;
a connection unit communicatably connected to an external apparatus having a second memory which backs up the data indicating the working contents to be stored in the first memory;
a backup unit configured to back up the data indicating the working contents to be stored in the first memory by the second memory; and
a processing unit configured to perform working concerning the image processing using the second memory in a case where it is not possible to perform the working using the first memory.

2. The image processing apparatus according to claim 1, further comprising a recovery unit configured to recover the data indicating the working contents backed up by the second memory in the replaced first memory, when the first memory is replaced.

3. The image processing apparatus according to claim 1, further comprising a setting unit which sets a type of the data indicating the working contents to be backed up by the backup unit.

4. The image processing apparatus according to claim 1, further comprising a key which operates the recovery unit.

5. The image processing apparatus according to claim 4, wherein the recovery unit operates in a case where the key has been input at a time when a power supply is turned on.

6. The image processing apparatus according to claim 1, wherein the external apparatus is another image processing apparatus.

7. The image processing apparatus according to claim 1, wherein the external apparatus is a computer apparatus.

8. The image processing apparatus according to claim 7, wherein the computer apparatus further comprises a drive capable of writing and reading the data with respect to detachably attached media, and the second memory is the media.

9. The image processing apparatus according to claim 1, further comprising a scanning unit which reads an image from a draft, and a printing unit which performs printing based on the image read by the scanning unit or printing data received via the connection unit,
wherein the image processing is at least one of a scanning process performed by the scanning unit, a network printing process performed by the printing unit, and a copy printing process performed by the scanning unit and the scanning unit.

10. The image processing apparatus according to claim 1, wherein the working is not performed using the first memory, when the first memory breaks down.

11. An image processing apparatus comprising:
first storage means for storing data indicating working contents concerning image processing;
connection means communicatably connected to an external apparatus having second storage means for backing up the data indicating the working contents to be stored in the first storage means;
backup means for backing up the data indicating the working contents to be stored in the first storage means by the second storage means; and
processing means for performing working concerning the image processing using the second storage means in a case where it is not possible to perform the working using the first storage means.

12. The image processing apparatus according to claim 11, further comprising recovery means for recovering the data indicating the working contents backed up by the second storage means in the replaced first storage means, when the first storage means is replaced.

13. A method of processing an image by an image processing apparatus, comprising:
storing data indicating working contents concerning image processing in a first memory;
backing up the data indicating the working contents to be stored in the first memory into a second memory of a communicatably connected external apparatus; and
performing working concerning the image processing using the data indicating the working contents, backed up by the second storage memory, in a case where it is not possible to perform the working using the first memory.

14. The image processing method of the image processing apparatus according to claim 13, further comprising recovering the data indicating the working contents backed up by the second memory in the replaced first memory, when the first memory is replaced.

15. The image processing method of the image processing apparatus according to claim 14, further comprising detecting an input of a key to start recovery at a time when a power supply is turned on.
